(19) United States
(12) Patent Application Publication
(10) Pub. No.: US 2009/0227476 A1
(43) Pub. Date: Sep. 10, 2009

(54) AMPLIFICATION AND MICROARRAY DETECTION APPARATUS AND METHODS OF MAKING

(75) Inventor: Alastair J. Malcolm, Scottsdale, AZ (US)

Correspondence Address: SNELL & WILMER L.L.P. (Main), 400 EAST VAN BUREN, ONE ARIZONA CENTER, PHOENIX, AZ, 85004-2202, US

(73) Assignee: APPLIED MICROARRAYS, INC., Tempe, AZ (US)

(21) Appl. No.: 12/400,753

(22) Filed: Mar. 9, 2009

Related U.S. Application Data
(60) Provisional application No. 61/034,671, filed on Mar. 7, 2008.

(51) Int. Cl. C40B 60/12; H01R 43/00

(52) U.S. Cl. 506/39; 29/825

(57) ABSTRACT

Various embodiments provide an improved integrated lab-on-chip apparatus which can perform PCR in one element of the apparatus, and thereafter can detect selected nucleic acids generated in the PCR by electrical addressing and interrogation methods on a microarray portion of the apparatus. Methods of manufacturing the improved integrated lab-on-chip are also provided.

### CROSS-REFERENCE TO RELATED APPLICATIONS

This application claims priority to U.S. Provisional Patent Application Ser. No. 61/034,671 entitled “Integrated PCR Microarray Lab-on-Chip Device for Electrical Detection of Nucleic Acids,” filed on Mar. 7, 2008, which is incorporated by reference herein.

### FIELD OF INVENTION

The present invention relates generally to microarray devices and relates more specifically to a combination amplification and microarray device.

### BACKGROUND

Molecular biology methods and instruments have been developed to isolate particular nucleic acid sequences of interest from tissues and cells. In addition, methods have been developed to amplify those sequences using polynucleotide chain reaction (“PCR”). Furthermore, methods have been developed to detect and quantify attributes of amplified nucleic acid sequences using microarrays. In general, microarrays contain capture probes that hybridize with a sample target and the hybridization event is typically detected using fluorescent luminescence or other such reporting.

As such important technologies have matured, various lab-on-chip devices have been developed to perform aspects of sample preparation and PCR amplification. Typically, lab-on-chip devices are placed on a substrate which may be a plastic, a ceramic, a silicon, a polymeric material, and the like. Typically, such lab-on-chip devices produce PCR amplicons which are detected and quantified on microarrays which are separate from the lab-on-chip device. In addition, such detection is typically done by fluorescence. Although use of microarrays and lab-on-chip devices are known, limitations in sample handling and optical detection exist. Improvements are thus needed for lab-on-chip devices that employ amplification and detection techniques.

### SUMMARY

Accordingly, in various embodiments, the present invention provides an improved integrated lab-on-chip apparatus which can perform PCR in one portion of the apparatus, and thereafter can detect selected nucleic acids generated in the PCR by electrical addressing and interrogation methods on a microarray portion of the apparatus.

Furthermore, in various embodiments, the present invention provides a device for performing sample preparation, PCR and electronic detection of hybridization. In various embodiments, the device includes a sample preparation device for receiving a biological sample and for preparing the biological sample for PCR; a PCR apparatus to receive the sample from the sample preparation device and to perform PCR or a nucleic acid target from the sample and to produce a target amplicon; an electronic detection microarray device operable to receive the target amplicon and to detect by an electrical means of a hybridization event of the target amplicon and a probe bound on a surface of the electronic detection microarray; and a support comprising the sample preparation device, the PCR apparatus, and the electronic detection microarray device, all coupled to a surface of the support.

Further areas of applicability will become apparent from the description provided herein. It should be understood that the description and specific examples are intended for purposes of illustration only, and are not intended to limit the scope of the present invention.

### BRIEF DESCRIPTION OF THE FIGURES

The drawing figures described herein are for illustration purposes only, and are not intended to limit the scope of the present invention in any way. The drawing figures described herein, unless indicated otherwise, are not to scale. The present invention will become more fully-understood from the detailed description and the accompanying figures, wherein:

FIG. 1 is a block diagram illustrating an amplification and a microarray detection apparatus according to various embodiments of the present invention;

FIG. 2 is a block diagram illustrating an amplification and microarray detection apparatus according to various embodiments of the present invention;

FIG. 3 is a block diagram illustrating an amplification and microarray detection apparatus according to various embodiments of the present invention;

FIG. 4 is a block diagram illustrating an amplification and microarray detection apparatus according to various embodiments of the present invention;

FIG. 5 is a block diagram illustrating an amplification and microarray detection apparatus according to various embodiments of the present invention;

FIG. 6 is a block diagram illustrating an amplification and microarray detection apparatus according to various embodiments of the present invention;

FIG. 7 is a block diagram illustrating an amplification and microarray detection apparatus according to various embodiments of the present invention;

FIG. 8 is a block diagram illustrating an amplification and microarray detection apparatus according to various embodiments of the present invention;

FIG. 9 is a top-view diagram illustrating an exemplary probe array on a microarray support;

FIG. 10 is a side-view diagram illustrating connections of a plurality of probes to a microarray support;

FIG. 11 is a block diagram illustrating an amplification and microarray detection device according to various embodiments of the present invention; and

FIG. 12 is a block diagram illustrating an exemplary method of making an amplification and microarray detection apparatus according to various embodiments of the present invention.

### DETAILED DESCRIPTION

The following description is merely exemplary in nature and is not intended to limit the present invention, its applications, or its uses. It is understood that throughout the drawing figures, corresponding reference numerals indicate like or corresponding parts and features. Description of specific examples indicated in various embodiments of the present invention are intended for purposes of illustration only, and are not intended to limit the scope of the invention disclosed herein. Moreover, recitation of multiple embodiments having stated features is not intended to exclude other embodiments having additional features or other embodiments incorporating different combinations of the stated features.

The present invention generally relates to a novel biological assay apparatus and a method of using the apparatus. In various embodiments, the apparatus includes a PCR device with connections to a microarray device on a common support or within the same apparatus. The apparatus and method may be used in either research or diagnostic applications.

While the ways in which the present invention addresses the drawbacks of the prior art are discussed in greater detail below, in general, the present invention provides a solution to the integration of instrumentation and devices which are otherwise separated. In addition, various embodiments of the present invention provide miniature lab-on-chip methods for PCR and microarrays, which can reduce the sample size required for analysis and can reduce the time and cost of such analysis.

The present invention provides improvements to the use of microarrays and lab-on-chip devices and methods in the assessment of the properties of human, animal and/or plant material through generation of information from DNA or RNA or any other form of nucleic acid. In various embodiments, the present invention provides an improved integrated lab-on-chip apparatus which can perform PCR in one element or portion of the apparatus, and thereafter can detect selected nucleic acids generated in the PCR by electrical addressing and interrogation methods on a microarray portion of the apparatus.

The nucleic acid sequences of the sample are isolated from biologic material, such as, for example, tissues or cells, and then can be presented to the PCR device on the apparatus. Within the PCR device, selected nucleic acid sequences are amplified, creating amplicons. Primers suitable for amplification of the selected nucleic acid sequences may be introduced to the PCR device along with the sample, or be pre-deposited on the PCR device prior to the sample introduction.

In various embodiments, a lab-on-chip apparatus or components thereof are used for the amplification of polynucleic acids, such as by PCR. Briefly, by way of background, PCR can be used to amplify a sample of target DNA or target sequence for analysis. Typically, the PCR reaction involves copying the strands of the target sequence and then using the copies to generate additional copies in subsequent cycles. Each cycle doubles the amount of the target sequence present, thereby resulting in a geometric progression in the number of copies of the target sequence. The temperature of a double-stranded target sequence is elevated to denature the DNA, and the temperature is then reduced to anneal at least one primer to each strand of the denatured target sequence. In various embodiments, the target sequence can be a cDNA. In various embodiments, primers are used as a pair—a forward primer and a reverse primer—and can be referred to as a primer pair or primer set. In various embodiments, the primer set comprises a 5′ upstream primer that can bind with the 5′ end of one strand of the denatured target sequence and a 3′ downstream primer that can bind with the 3′ end of the other strand of the denatured target sequence. Once a given primer binds to the strand of the denatured target sequence, the primer can be extended by the action of a polymerase. In various embodiments, the polymerase can be a thermostable DNA polymerase, for example, a Taq polymerase. The product of this extension, which sometimes may be referred to as an amplicon, can then be denatured from the resultant strands and the process can be repeated. Temperatures suitable for carrying out the reactions are well known in the art.

In various embodiments, methods are provided for detecting a plurality of targets. Such methods include those comprising forming an initial mixture comprising an analyte sample suspected of comprising the plurality of targets, a polymerase, and a plurality of primer sets. In various embodiments, the initial mixture can be formed under conditions in which one primer elongates if hybridized to a target.

In various embodiments, the present invention provides methods and apparatus for Reverse Transcriptase PCR (RT-PCR), which includes the amplification of a Ribonucleic Acid (RNA) target. In various embodiments, assay can comprise a single-stranded RNA target, which comprises the sequence to be amplified (e.g., an mRNA), and can be incubated in the presence of a reverse transcriptase, two primers, a DNA polymerase, and a mixture of dNTPs suitable for DNA synthesis. During this process, one of the primers anneals to the RNA target and can be extended by the action of the reverse transcriptase, yielding an RNA/cDNA doubled-stranded hybrid. This hybrid can then be denatured and the other primer anneals to the denatured cDNA strand. Once hybridized, the primer can be extended by the action of the DNA polymerase, yielding a double-stranded cDNA, which then serves as the double-stranded target for amplification through PCR, as described herein. RT-PCR amplification reactions can be carried out with a variety of different reverse transcriptases, and in various embodiments, a thermostable reverse-transcription can be used. Suitable thermostable reverse transcriptases can comprise, but are not limited to, reverse transcriptases, such as AMV reverse transcriptase, MuLV, and Tth reverse transcriptase.

In various embodiments, the amplicons are transferred to a microarray device within the same apparatus, or on a common support with the PCR device. An assay is then performed to stimulate hybridization of the amplicons to the capture probes on the microarray. The capture probes may be constructed from sequences of nucleic acid, and may include additional molecules to the ends or in the body of the nucleic acid sequence. These additional molecules may be used to improve the assay efficiency, provide the detection capability, and also extend the range of types of nucleic acid targets that are captured. For example, the capture probe may be present invention can extend the range of tests through the use of an extended range of sample targets and capture probe molecule types.

The present invention provides assays for genotyping and detection of mutations and single nucleotide polymorphisms using an integrated PCR device and e-array device. In addition, assays for determination of DNA methylation state using an integrated PCR device and e-array device are provided. Assays for determination of gene expression using an integrated PCR device and e-array device are provided.

Assays for analysis of small RNA molecules using an integrated PCR device and e-array device are provided. Small RNA molecules, such as, for example, micro RNAs (miRNA), short interfering RNAs (siRNA), small temporal RNAs (stRNA) and short nuclear RNAs (snRNA), can be, typically, less than about 40 nucleotides in length and can be of low abundance in a cell. With appropriate probe elements, lab-on-chip apparatus can detect miRNA expression found in, for instance, cell samples taken at different stages of development. In various embodiments, lab-on-chip apparatus can be used to validate that siRNA molecules have successfully, post-translationally, regulated the gene expression patterns of interest. In various embodiments, such methods may be useful during the manipulation of gene expression patterns using siRNAs in order to elucidate gene function and/or interrelationships amongst genes. In various embodiments, gene expression patterns can be introduced into living cells, cellular assays can be seen on lab-on-chip apparatus and can reveal gene functions. In various embodiments, analysis for small RNA can be run on lab-on-chip apparatus allowing for a high number of simultaneous assays on a single sample with performance that obviates the need for secondary assays to validate the gene expression results. chemically and/or structurally modified to provide the capability to electronically detect the methylation state of DNA, and thereafter that information on the methylation state may be used for research or diagnostic purposes.

In various embodiments, the hybridization event of one of the selected nucleic acid sequences of the sample to one of the capture probes can be detected electronically through changes in the electrical properties. Additional molecules, metals, and conjugates may be included on at least one of the samples, assay chemicals, the capture probes, and/or the microarray supports to improve the detection of the hybridization event.

Various embodiments of the present invention provide apparatus and methods that have broad utility in human, animal and plant disease characterization and health management. In human and animal drug development programs, the apparatus and method of the present invention can be used to improve assessment of therapeutic candidate effects. In agricultural applications, the apparatus and method of the present invention can provide superior characterization of the relationship of particular nucleic acid sequences to plant health, disease resistance, and/or climate change adaptability.

In various embodiments, the apparatus and method of the present invention can provide improved efficiency in diagnosing disease, including, for example, shorter time-to-answer, improved fidelity of results, and/or lower assay reagent costs compared to technology that uses conventional PCR combined with microarray detection techniques. In various embodiments, the apparatus and method of the present invention can reduce lab space and equipment cost through integration of multiple aspects of process instrumentation into a common apparatus or common support. In various embodiments, the apparatus and method of the

In various embodiments, the present invention integrates, in the same apparatus or common support, a PCR device constructed from, for example, silicon or ceramic microchannels which use electrical heating of embedded elements, with a microarray which uses electrical detection of nucleic acid hybridization events. In addition, exemplary embodiments of the present invention can provide electrical detection methods on a microarray to indicate the methylation state of the target nucleic acid.

Various embodiments of the present invention provide a device for performing sample preparation, PCR and electronic detection of hybridization. In various embodiments, the device can include: a sample preparation device operable for receiving a biological sample and for preparing the biological sample for PCR; a PCR apparatus operable to receive the sample from the sample preparation device and to perform PCR on at least one nucleic acid target from the sample to produce at least one target amplicon; an electronic detection microarray device operable to receive the at least one target amplicon and to detect by an electrical means a hybridization event of the at least one target amplicon to at least one probe bound on a surface of the electronic detection microarray; and a support having a first surface and an opposing second surface, the at least one of the first surface and the second surface comprising the sample preparation device, the PCR apparatus and the electronic detection microarray device.

In an aspect of the present invention, all of the sample preparation device, PCR device, and e-array device are located on a common support or substrate. In another aspect, PCR device and e-array device are located on a common support or substrate. In aspects of the present invention, PCR device and e-array device are coupled separate supports, but contained within the same overall apparatus so as to allow direct transfer of PCR products to the e-array device. Supports or substrate can be formed from any of the types of circuit boards commonly used in the electronics industry to attach active and passive semiconductor devices. Various portions of substrate can be treated differently to provide at least one of chemical, thermal, electrical, and biological compatibility of that particular step or device of the process that is to be performed. Substrate construction enable attachment of the sample preparation, PCR, and e-array elements by soldering, welding, gluing, thermal, chemical means, and the use of intermediate materials to provide the required attachment characteristics. Fluids, reagents, samples, amplicons, and other materials may be transported between portions the various devices on the substrate via micro-channels or tubing.

The present invention provides assay methods that can be performed in a miniature device or nanoscale device which includes a sample prep device, a PCR device and an e-array. Various probe-target reactions may be detected using a labeling technology on e-array, including at least one of fluorescence, quantum dots, chemiluminescence, magnetic, radioactive, and/or colorimetric labeling technologies, and at least one detection method being an electronic probe element on e-array. Such probe element can be natural or synthetic. In aspects of the present invention, the assay methods can employ automated or manual systems, which can vary the assay conditions, and independently deliver different reagents and target mixes, within various portions of a miniature device or nanoscale device to support hybridization detection.

The following definitions are used herein:

DNA is deoxyribonucleic acid, in either single- or double-stranded form, including analogs that can function in a similar manner.

RNA is ribonucleic acid in either single- or double-stranded form, including analogs that can function in a similar manner.

PCR is a polymerase chain reaction method to amplify selected sequences of nucleic acid. A PCR method may be performed in either a stationary or continuous flow method.

“Array” is used interchangeably with “microarray” and “e-array” and refers to a multitude of different capture probe elements on a support.

“Target” is used to describe the nucleic acids which are intended to be amplified by PCR and transferred for analysis on the array.

“Assay” is used to describe the steps taken to hybridize the target to the probes, then subsequently analyze the hybridization events.

“CpG” is used to describe regions of DNA where a Cytosine nucleotide occurs next to a Guanosine nucleotide in the linear sequence of bases along its length.

“CpG-islands” are regions of DNA which have a higher than average concentration of CpG sites.

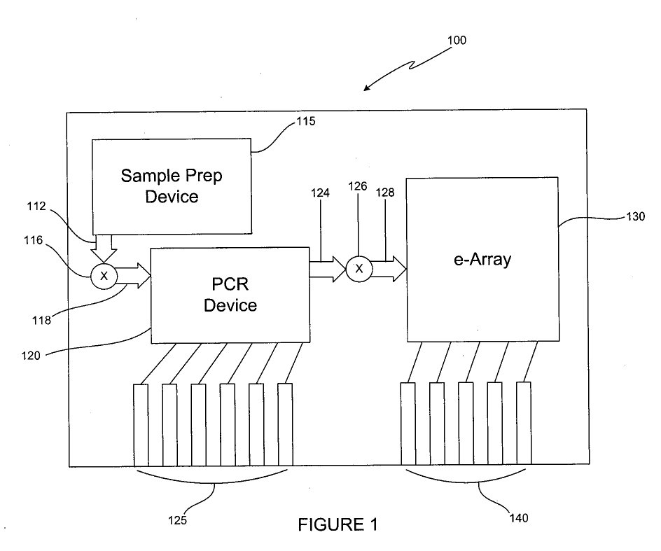

With initial reference to FIG. 1, apparatus 100, according to various embodiments of the present invention, is illustrated. Apparatus 100 includes substrate 110, sample prep device 115, PCR device 120, and e-array 130. In various embodiments of the present invention, sample prep device 115, PCR device 120, and e-array 130 are coupled to a surface of substrate 110. In various embodiments, sample prep device 110, PCR device 120, and e-array 130 can be coupled to one another in series.

In various embodiments, substrate 110 can be of any varying dimension and can be formed from any material or combination of materials that are electrical insulators. For example, substrate 110 can be formed of ceramics, silicon, glass, quartz, plastics, polymeric materials, combinations thereof, and the like. In another example, substrate 110 can be, in a simple form, a microscope slide. In an exemplary embodiment, substrate 110 is a ceramic or silicon wafer.

Sample prep device 115 may be coupled to substrate 110, comprising PCR device 120 and e-array 130. Fluids can be transferred from sample prep device 115 to PCR device 120 using one or more of pressure, gravity, mechanical displacement, capillary fluidics, and/or pumping. Fluids can be transferred from sample prep device 115 to PCR device 120 using one of movement of particles stimulated by electrical, thermal or magnetic means.

Any sample that has been isolated from biologic material, such as, for example, tissues or cells, can be presented to sample prep device 115. A sample can be from a prokaryote or eukaryote source. A sample can be derived from a human or animal tumor or healthy tissue sample, or plurality of cells from healthy or diseased tissue. A sample can be derived from blood cells, saliva, spinal fluid, cerebral fluid, urine or stool. The target biological sample populations can be derived from any biological source, including human, plant and animal tissue. For example, a tissue sample can be any tissue, including a newly obtained sample, a frozen sample, a biopsy sample, a blood sample, an amniocentesis sample, preserved tissue, such as a paraffin-embedded fixed tissue sample (i.e., a tissue block), or a cell culture. Thus, a tissue sample can be, but is not limited to, a whole blood sample, a skin sample, epithelial cells, soft tissue cells, fetal cells, amniocytes, lymphocytes, granulocytes, suspected tumor cells, organ tissue, blastomeres, and/or polar bodies. In addition, a tissue to analyzed be can be derived from a micro-dissection process.

Any number and type of fluid introduction ports and valves may be used to exchange fluids into and out of sample prep device 115. Valves may be present on the device to control transfer of materials into and out of various chambers within PCR device 120 and sample prep device 115. These valves may be operated by electrical, magnetic, thermal, pneumatic or other mechanical methods. With reference to FIG. 1, prepped sample 112 exits sample prep device 115 and can be controlled by valve 116 to PCR entry 118 of PCR 120.

In various embodiments, PCR device 120 can generate multiple replicates of the selected nucleic acid sequences or targets to produce a plurality of amplicons. PCR device 120 can be of any shape or size, as long as it fits on substrate 110. PCR device may have one reaction area or a plurality of reaction areas. As illustrated in FIG. 1, PCR device 120 is coupled to the same substrate 110 surface as e-array 130. PCR device 120 may be constructed of any suitable materials, such as, for example, plastics, ceramics, silicon, and combinations thereof. Each of these materials may also have appropriate coatings to improve the performance and/or efficiency of a PCR reaction in PCR device 120.

The thermal cycles of PCR device 120 may be achieved via heating and cooling from internal elements or from external elements. Heating may be achieved by the change in temperature of resistive elements within the body of PCR device 120 due to electrical current flow. The heating cycle of the PCR process can be produced by passing electrical current through resistive elements contained in substrate 110, and the cooling is by radiation, or convection, or cooling channels within substrate 110.

Heating may be achieved by remote radiation acting on elements of the chamber, for example, by microwave radiation or magnetic induction. Cooling of

PCR device 120 may be achieved by radiative or conductive means, with or without an additional cooling apparatus. The heating cycle of the PCR process can be produced by radiation or convection from an external heat source, and cooling is via radiation or conduction via an external heat sink. Alternatively, PCR device 120 may amplify target amplicons using isothermal methods. Temperature sensors may be included in PCR device 120 to provide temperature readings and to be part of an electronic temperature control system.

Chemical reagents, nucleic acid primers, enzymes and other fluids may be added to PCR device 120 to improve the efficiency and selectivity of amplification. In various embodiments, the PCR primers and other reagents to support the PCR process can be deposited on a support located prior to the input ports of the PCR thermal cycling region of PCR device 120. In various embodiments, the PCR primers are deposited on the same support as the PCR thermal cycling region of PCR device 120.

In various embodiments, the PCR primers are deposited within channels or chambers in which the PCR thermal processes are performed in PCR device 120. In an exemplary embodiment, PCR device 120 can enable the PCR process to take place in microchambers or microchannels within, for example, a silicon, ceramic, or plastic portion of PCR device 120. In various embodiments, input and/or output areas of the PCR thermal cycling chamber of PCR device 120 contain valves which consist of a single-use fusible material. The creation of an opening in the fusible material to allow transport of fluids from one segment to the other may be stimulated by electrical, thermal or chemical methods. In an exemplary embodiment, the input or output areas of the PCR thermal cycling chamber of PCR device 120 may be separately enclosed. In an exemplary embodiment, the input and/or output areas of the PCR thermal cycling chamber of PCR device 120 may be separately heated or cooled. In an exemplary embodiment, the input or output areas of the PCR thermal cycling chamber of PCR device 120 may be separately supplied with particular reagents suitable for enabling the PCR process, or preparation for the e-array hybridization and detection processes.

Input and/or output areas of the thermal cycling chamber of PCR device 120 can contain valves which consist of a single-use fusible material. The chamber or chambers of PCR device 120 may contain single-use fusible ports and fusible valves to support the introduction, removal and isolation of fluids during various steps of processing by the sample preparation device 115, PCR device 120, and e-array 130. The creation of an opening in the fusible material to allow transport of fluids from one device to the other of the apparatus may be stimulated by electrical, thermal or chemical methods.

In various embodiments, amplicons 124 may be removed from PCR device 120 by any physical method, including, but not limited to, pressure, pumping, thermal, gravity, or can be contained in a fluid flow created by the stimulated movement of other particles contained in a fluid comprising amplicons 124. Valves may be present on apparatus 100 to control transfer of materials into and out of various chambers within PCR device 120. These valves may be operated by electrical, magnetic, thermal, pneumatic or other mechanical methods. As illustrated in FIG. 1, amplicons 124 can be controlled by valve 126 for presentation in e-array entry 128 for detection in e-array 130.

In various embodiments, e-array 130 includes a plurality of probes coupled to substrate 115. Substrate 115 can have areas which have the properties of an electrical insulator. On the surface or within the body of the insulating regions, electrically conductive elements can be used to transfer electrons between the probes and the control and analysis instrumentation. These conductors can be composed of any materials that can behave as an electrical conductor.

The probe elements of e-array 130 can be of varying dimension, shape, area, spacing and volume. Probe elements may be of any concentration, and contained in any liquid prior to deposition on substrate 110. The probe elements can have physically separated spots produced by printing methods, for example, mechanical transfer, engraving, contact or non-contact print methods. Probe elements can be transferred from their sources to substrate 110 or e-array surface in any desired automated or manual manner. Probe elements and substrate 110 can be designed and fabricated to allow for electrical detection of a target that hybridizes to a probe. Some or all of the probe elements also can be closely abutted or overlap. Some or all of the individual probes can be mixed before, during, or after deposition on the support.

The probe element density can be any desired density. In an exemplary embodiment, probe elements may be attached to intermediate materials which are located on or within substrate 110, such as, for example, beads, nanofibers, nanoparticles, polymers, plastics, metals, colloids, papers or combinations thereof. Additional intermediate materials may be attached to the ends or the body of the probe elements to promote various aspects of the probe's ability to hybridize to the sample or target, or for a hybridization event to be detected electrically. The probe elements of the e-array can be attached to substrate 110 by any physical, chemical, or biological methods, and with intermediate compounds and materials to achieve the desired attachment and electron transfer characteristics.

The nucleic acid sequences of the probe elements can include any type of nucleic acid or nucleic acid analog, including, without limitation, RNA, DNA, PNA, and LNA. Single and double stranded versions of the probes are included. The nucleic acids in the probe elements may be of any length, and include additional chemical groups at the ends or in the body of the nucleic acid chain. Some of the sequence of the probe elements can be designed to be complementary to the sample target nucleic acid sequence, and thereby capture the probe via hybridization. The probe chemistry may be additionally modified to make it suitable for detection of DNA methylation.

The target materials isolated from the biological sample, following the PCR process in PCR device 115, are hybridized to the probe elements on the e-array 130 under suitable hybridization and labeling conditions selected to permit capture and also electronic detection of target nucleic acid sequences. The hybridization and labeling conditions include choice of time, temperature, chemistry, and ambient environment.

As illustrated in FIG. 1, apparatus 100 can include a first set of electrical contacts 125 in communication with PCR device 120. In addition, apparatus 100 can include a second set of electrical contacts 140 in communication with e-array 130. At least one of first set of electrical contacts 125 and second set of electrical contacts 140 can be useful for control and/or data collection from apparatus 100 when coupled to an instrument designed to operate apparatus 100.

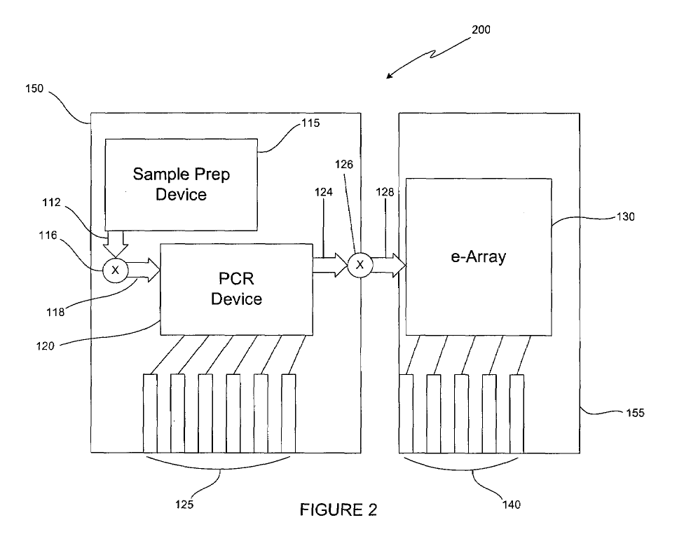

Moving to FIG. 2, an apparatus 200, according to various embodiments of the present invention, is illustrated. Apparatus 200 includes first substrate 150, second substrate 155, sample prep device 115, PCR device 120, and e-array 130. In various embodiments of the present invention, sample prep device 115 and PCR device 120, are coupled to a surface of first substrate 150, and e-array 130 is coupled to a surface of second substrate 155. In various embodiments, sample prep device 115, PCR device 120, and e-array 130 can be coupled to one another in series, as described herein.

In various embodiments, first substrate 150 and second substrate 155 are substantially similar to substrate 110 described above. In an exemplary embodiment, at least one of first substrate 150 and second substrate 155 is equivalent to substrate 110. Apparatus 200 can also include prepped sample 112, valve 116, PCR entry 118, amplicons 124, valve 126, and e-array entry 128, as described herein. In addition, apparatus 200 can include first electrical contacts 125 and second set of electrical contacts 140, as described herein.

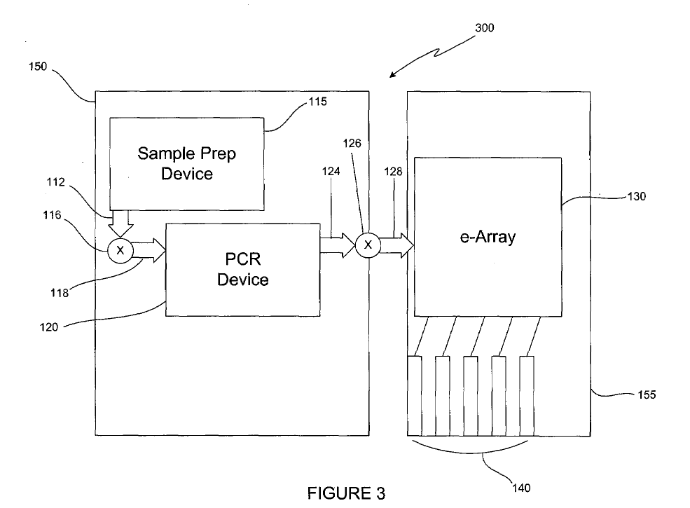

With reference to FIG. 3, apparatus 300, according to various embodiments of the present invention, is illustrated. Apparatus 300 includes first substrate 150, second substrate 155, sample prep device 115, PCR device 120, and e-array 130. In various embodiments of the present invention, sample prep device 115 and PCR device 120 are coupled to a surface of first substrate 150, and e-array 130 is coupled to a surface of second substrate 155. In various embodiments, sample prep device 110, PCR device 120, and e-array 130 can be coupled to one another in series, as described herein.

In various embodiments, first substrate 150 and second substrate are substantially similar to substrate 110 described above. In an exemplary embodiment, at least one of first substrate 150 and second substrate 155 is equivalent to substrate 110. Apparatus 300 can also include prepped sample 112, valve 116, PCR entry 118, amplicons 124, valve 126 and e-array entry 128, as described herein. In addition, apparatus 300 can include second set of electrical contacts 140, as described herein. In an exemplary embodiment, apparatus 300 does not include a communication from PCR device 120 to an instrument that can control PCR device 120 from an external source.

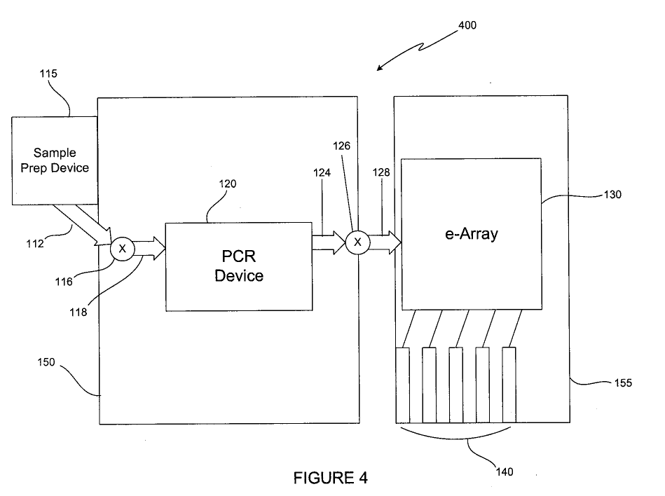

Turning to FIG. 4, apparatus 400, according to various embodiments of the present invention, is illustrated. Apparatus 400 can include first substrate 150, second substrate 155, sample prep device 115, PCR device 120, and e-array 130. In various embodiments of the present invention, PCR device 120 is coupled to a surface of first substrate 150, e-array 130 is coupled to a surface of second substrate 155, and sample prep device 115 is external to first substrate 150 and second substrate 155. In various embodiments, sample prep device 115, PCR device 120, and e-array 130 can be coupled to one another in series, as described herein.

In various embodiments, first substrate 150 and second substrate 155 are substantially similar to substrate 110 described above. In an exemplary embodiment, at least one of first substrate 150 and second substrate 155 is equivalent to substrate 110. Apparatus 400 can also include prepped sample 112, valve 116, PCR entry 118, amplicons 124, valve 126 and e-array entry 128, as described herein. In addition, apparatus 400 can include second set of electrical contacts 140, as described herein. In an exemplary embodiment, apparatus 400 does not include a communication from PCR device 120 to an instrument that can control PCR device 120 from an external source.

An assay on e-array 130 can be performed in a chamber or enclosure of a cartridge type device of any dimensions and can be formed from plastics, ceramics, silicon, glass, nanomaterials or combinations thereof. In one aspect, PCR device 120 and e-array 130 can be located within the same chamber of a cartridge. In another aspect, PCR device 120 can be located in a first chamber that isolates PCR device 120 from e-array 130 which can be isolated in a second chamber. Amplicons 124 from PCR device 120 in a first chamber can be transferred to the e-array device in a second chamber by any fluid transport method. In some aspects of the present invention, the chamber or chambers may contain ports and valves to support the introduction, removal and isolation of fluids when employing at least one of sample preparation device 115, PCR device 120, and e-array device 130.

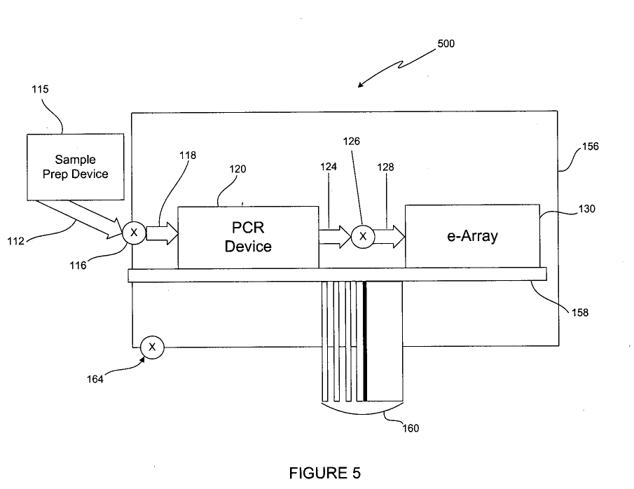

In FIG. 5, apparatus 500, according to various embodiments of the present invention, is illustrated. Apparatus 500 can include substrate 158, sample prep device 115, PCR device 120, e-array 130 and hybridization chamber 156. In various embodiments of the present invention, PCR device 120 and e-array 130 are coupled to a surface of substrate 158 and prep device 115 is not coupled to substrate 158. In various embodiments, sample prep device 115, PCR device 120, and e-array 130 can be coupled to one another in series, as described herein.

In various embodiments, substrate 158 is substantially similar to substrate 110 described above. In an exemplary embodiment, substrate 158 is equivalent to substrate 110. Apparatus 500 can also include prepped sample 112, valve 116, PCR entry 118, amplicons 124, valve 126 and e-array entry 128, as described herein. In addition, apparatus 500 can include electrical contacts 160, useful for communication of apparatus 500 with an external instrument. Such communication can be at least one of control of apparatus 500 and data collection from apparatus 500.

In various embodiments, apparatus 500 can comprise hybridization chamber 156. In an exemplary embodiment, hybridization chamber 156 can seal contents of apparatus 500 from external elements, such as, for example, contaminants, dirt, and the like. In an exemplary embodiment, hybridization chamber 156 contains an inert gas, such as, for example, nitrogen, argon, or helium. In an exemplary embodiment, hybridization chamber 156 reduces evaporation of reagents or other solutions in sample prep device 115, PCR device 120, e-array 130, or on the surface of substrate 158.

In various embodiments, the application of amplicons 124 on to e-array 130 may take place inside hybridization chamber 156. Amplicons 124 can be transferred from PCR device 120 into hybridization chamber 156 using any one or a combination of pressure, gravity, mechanical displacement, and/or pumping, or in the fluid flow caused by movement of particles stimulated by electrical, thermal or magnetic means. In an exemplary embodiment, PCR device 120 may be contained within hybridization chamber 156 which contains e-array 130, or within another segment of that enclosure that is isolated. Any number and type of fluid introduction ports and valves, such as 164 and 166, may be used to exchange fluids into and out of the hybridization chamber enclosure. Valves, such as valve 116, may be present on apparatus 500 to control transfer of materials into and out of various chambers within PCR device 120 and chamber 156. These valves may be operated by electrical, magnetic, thermal, pneumatic or other mechanical methods. As used herein, a valve can be any fluid metering device, micro fluidic device, or any on/off device.

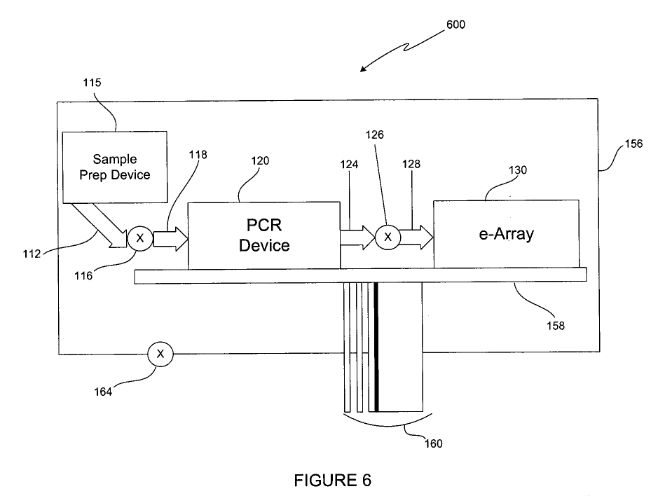

Now with reference to FIG. 6, apparatus 600, according to various embodiments of the present invention, is illustrated. Apparatus 600 can include substrate 158, sample prep device 115, PCR device 120, e-array 130 and hybridization chamber 156. In various embodiments of the present invention, prep device 115, PCR device 120 and e-array 130 can be coupled to a surface of substrate 158. In various embodiments, sample prep device 115, PCR device 120, and e-array 130 can be coupled to one another in series, as described herein.

In various embodiments, substrate 158 is substantially similar to substrate 110 described above. In an exemplary embodiment, substrate 158 is equivalent to substrate 110. Apparatus 600 can also include prepped sample 112, valve 116, PCR entry 118, amplicons 124, valve 126 and e-array entry 128, as described herein. In addition, apparatus 600 can include electrical contacts 160 useful for communication of apparatus 800 with an external instrument. Such communication can be at least one of control of apparatus 600 and/or data collection from apparatus 600.

As described herein, apparatus 600 can comprise hybridization chamber 156. In an exemplary embodiment, hybridization chamber 156 can seal contents of apparatus 600 from external elements, such as, for example, contaminants, dirt, and the like. In an exemplary embodiment, hybridization chamber contains an inert gas, such as, for example, nitrogen, argon, or helium. In an exemplary embodiment, hybridization chamber 156 reduces evaporation of reagents or other solutions in sample prep device 115, PCR device 120, e-array 130, or on surface of substrate 158.

In various embodiments, the application of amplicons 124 on to e-array 130 may take place inside hybridization chamber 156. Amplicons 124 can be transferred from PCR device 120 into hybridization chamber 156 using any one or a combination of pressure, gravity, mechanical displacement, and/or pumping, or in the fluid flow caused by movement of particles stimulated by electrical, thermal or magnetic means. In an exemplary embodiment, PCR device 120 may be contained within hybridization chamber 156 which contains e-array 130, or within another segment of that enclosure that is isolated. Any number and type of fluid introduction ports and valves, such as 164, may be used to exchange fluids into and out of the hybridization chamber enclosure. Valves, such as valve 116, may be present on apparatus 600 to control transfer of materials into and out of various chambers within PCR device 120 and chamber 156. These valves may be operated by electrical, magnetic, thermal, pneumatic or other mechanical methods.

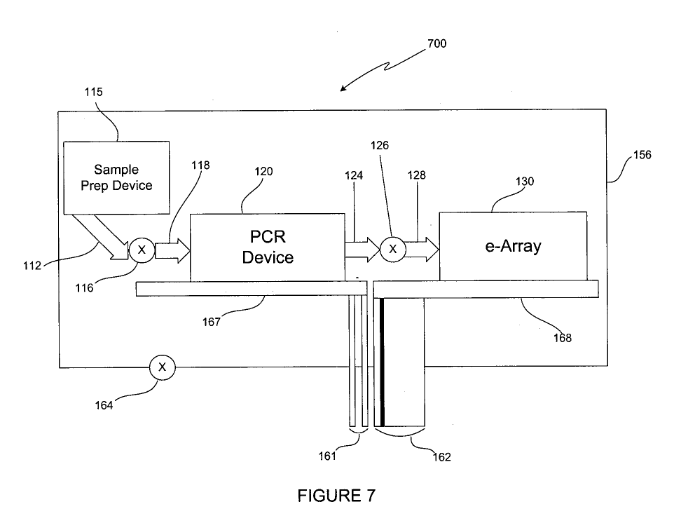

Moving to FIG. 7, apparatus 700, according to various embodiments of the present invention, is illustrated. Apparatus 700 can include first substrate 167, second substrate 168, sample prep device 115, PCR device 120, e-array 130 and hybridization chamber 156. In various embodiments of the present invention, sample prep 115 and PCR device 120 are coupled to a surface of first substrate 157, and e-array 130 is coupled to a surface of second substrate 168. In various embodiments, sample prep device 115, PCR device 120, and e-array 130 can be coupled to one another in series, as described herein.

In various embodiments, first substrate 167 and second substrate 168 are substantially similar to substrate 110 described above. In an exemplary embodiment, at least one of first substrate 167 and second substrate 168 is equivalent to substrate 110. Apparatus 700 can also include prepped sample 112, valve 116, PCR entry 118, amplicons 124, valve 126 and e-array entry 128, as described herein. In addition, apparatus 700 can include first electrical contacts 161 and second electrical contacts 162, useful for communication of apparatus 700 with an external instrument. Such communication can be at least one of control of apparatus 700 and data collection from apparatus 700. In various embodiments, apparatus 700 can comprise hybridization chamber 156, as described herein.

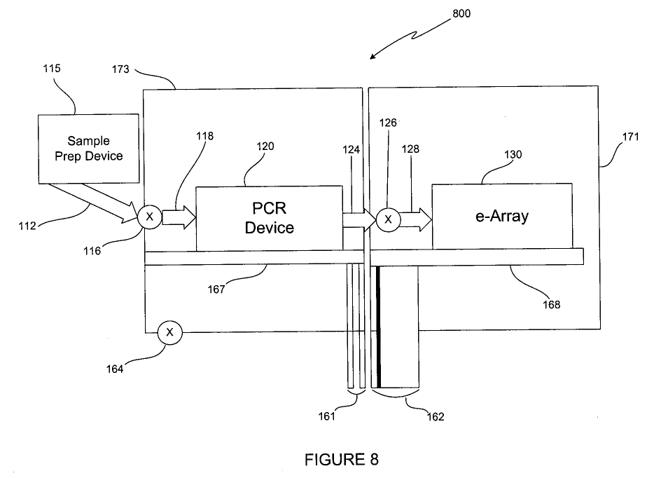

Referring to FIG. 8, apparatus 800, according to various embodiments of the present invention, is illustrated. Apparatus 800 can include first substrate 167, second substrate 168, sample prep device 115, PCR device 120, e-array 130, first hybridization chamber 173, and second hybridization chamber 171. In various embodiments of the present invention, sample prep 115 and PCR device 120 are coupled to a surface of first substrate 157 being contained in first hybridization chamber 173, and e-array 130 is coupled to a surface of second substrate 168 being contained in second hybridization chamber 171. In various embodiments, sample prep device 115, PCR device 120, and e-array 130 can be coupled to one another in series, as described herein.

In various embodiments, first substrate 167 and second substrate 168 are substantially similar to substrate 110 described above. In an exemplary embodiment, at least one of first substrate 167 and second substrate 168 is equivalent to substrate 110. In various embodiments, first hybridization chamber 173 and second hybridization chamber 171 are substantially similar to hybridization chamber 156. In an exemplary embodiment, at least one of first hybridization chamber 173 and second hybridization chamber 171 is equivalent to hybridization chamber 156. Apparatus 800 can also include prepped sample 112, valve 116, PCR entry 118, amplicons 124, valve 126, and e-array entry 128, as described herein. In addition, apparatus 800 can include first electrical contacts 161 and second electrical contacts 162, useful for communication of apparatus 800 with an external instrument. Such communication can be at least one of control of apparatus 800 and data collection from apparatus 800.

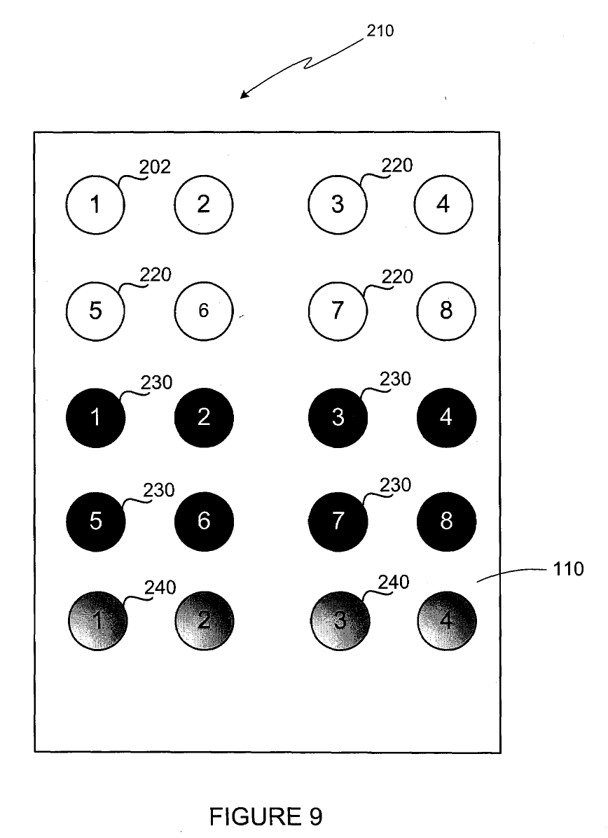

Turning now to FIG. 9, e-array 210, according to various embodiments of the present invention, is illustrated. E-array 210 can have a plurality of probe elements coupled to substrate 110. For example, the plurality of probe elements can include a plurality of first probe type 220 (having a non-limiting number of eight probes illustrated), a plurality of second probe type 230 (also having a non-limiting number of eight probes illustrated), and a plurality of third probe type 240 (having a non-limiting number of four probes illustrated). Any number of probes may be used and any number of different probe types may be used. For example, if a genome of a particular species is to be analyzed, as many as 30,000 different probe types may be coupled onto substrate 110. In addition, a repetition of a plurality of each of the 30,000 different probes may be included on the e-array 210. Further, for such an analysis, additional probes may be included as controls to be used during data analysis of the results. In all, for the analysis of a genome of a particular species, over 100,000 individual probe elements may be coupled to substrate 110 for use in e-array 210.

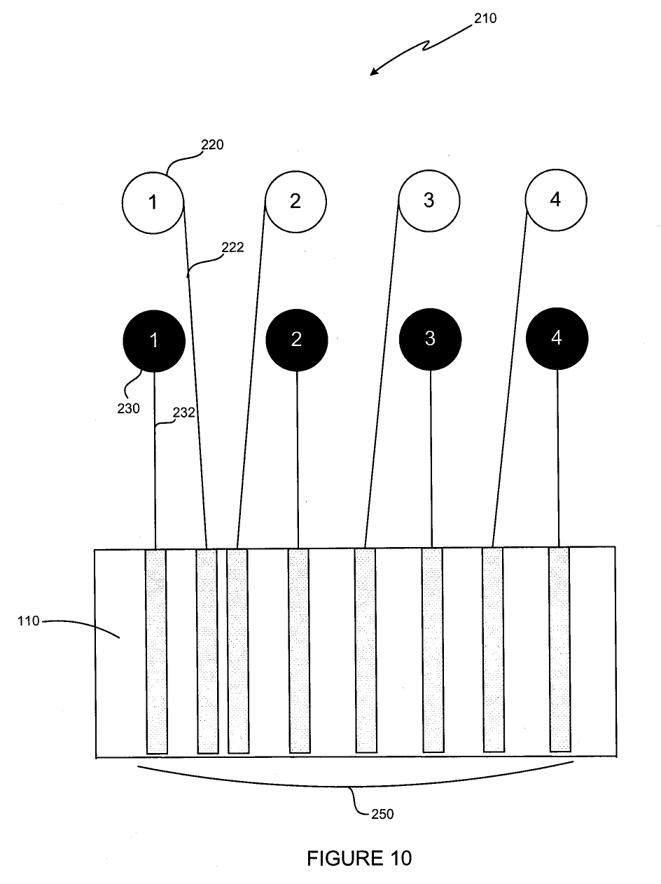

Moving to FIG. 10, a side view of e-array 210 is illustrated according to various embodiments of the present invention. E-array 210 can include a plurality of probe elements coupled to set of electrical contacts 250 on substrate 110. Each of the plurality of probes can be coupled to an individual contact in set of electrical contacts 250. During a hybridization event, an amplicon hybridizes to an appropriate probe and this hybridization event produces an electrical signal that can be directed to an individual contact in set of electrical contacts 250. This is how the apparatus, such as apparatus 100 and other exemplary embodiments described herein, detects a sample. This electrical signal can be directed from e-array 210 (or 130 as described herein) to an external instrument for collection and analysis.

In aspects of the present invention, electronic stimulation of reactions, such as hybridization, on e-array 210 can be via direct or alternating current at any frequency or combination of frequencies. An electronic analysis of the signals from reactions, such as hybridization, on e-array 210 can be via direct or alternating current at any frequency or combination of frequencies. An electronic analysis of the signals from reactions, such as hybridization, on e-array 210 can be via any electronic instrument using any software approach to analyze the signal. The electrical signal can be amplified, digitized, normalized, and/or the like for improved data collection and/or analysis. Such methods of manipulating an electrical signal from a microarray are well known by those skilled in that art.

In various embodiments, high-density array of gold electrodes can be incorporated into e-array 130. In various embodiments, capture probes and signal probes can be designed and manufactured for a specific target sequence. In various embodiments, capture probes can be coated onto the gold electrodes forming a monolayer on the gold surface. In various embodiments, signal probes can be tagged with ferrocenes. In various embodiments, the target sequence can be amplified by PCR and when added to the monolayers on the gold electrodes, specific target sequences can hybridize to the capture probe. An electrochemical signal can be generated when the amplicon hybridizes to the capture probe and the ferrocene-labeled signal probe, thereby bringing a reporter molecule, ferrocene, into contact with the monolayer on the gold electrode. In various embodiments, an AC voltammogram is obtained when the specific target sequence is detected in a sample, but no electronic signal is registered when the specific target sequence is absent from the sample.

Target sequence can be bound to electrical contacts on substrate 110 via specific binding to the capture probe attached to the electrode by a self-assembled monolayer. The signal probe binds to the target sequence adjacent to the base of the capture probe, and associated ferrocene labels are detected at the electrode surface by alternating current voltometry. Such probes on substrate 110 allow for detection of high specificity in a multiplexed geonotyping test. Such probes on e-array 210 can eliminate a wash step after the amplicons enter e-array. In addition such probes can minimize detection artifacts by e-array 210.

Each of the electric contacts on e-array can be coupled to a covalently-bound oligonucleotide capture probe within a self-assembled monolayer of insulator molecules on substrate 110. Each pair of electric contacts has a different capture probe. Single-stranded target sequence can be produced by PCR device 120 and then can hybridize to the appropriate immobilized capture probe and to soluble signal probes. The allele-specific ferrocene labels on the probes can detect by alternating current voltammetry, resulting in signals at the redox potential characteristic of one or more alleles and hybridized target sequence.

In various embodiments, selective and real-time detection of label-free target sequence by e-array 210 provides electronic readout. Microfabricated silicon field-effect sensor probe elements can be included in the e-array 210 to directly monitor the increase in surface charge when a target sequence hybridizes on the sensor surface. The electrostatic immobilization of the probe element on a positively charged poly-L-lysine layer allows hybridization of a target sequence at low ionic strength where field-effect sensing is most sensitive. Nanomolar concentrations of target sequences can be detected within minutes, and a single base mismatch within 12-mer oligonucleotides can be distinguished by using a differential detection technique with two sensors in parallel. The sensor probe elements can be fabricated by standard silicon microtechnology during formation of e-array 210.

In various embodiments, e-array probe elements, or mixtures thereof, can be previously prepared and then deposited in liquid, gel, or solid form onto the support via contact printing, non-contact printing, stamping, electrospray, or acoustic ejection of droplets on to the e-array. In an aspect of the embodiments, some or all of the e-array probe elements can be synthesized on the e-array portion of substrate, including, but not limited to, chemical synthesis, light-stimulated synthesis, electrically-stimulated, and magnetically-stimulated synthesis. The e-array device can include probe elements of any size or shape, and any quantity of unique or replicate probes.

In an aspect of the invention, e-array probe elements can be attached or coupled to intermediate materials between probe elements and electrical contact in substrate. Probe elements can be conjugated with or attached to other materials in order to provide attachment to either the support or the target sequence or intermediate molecules between target sequence and probe elements. Probe elements can contain additional molecules, compounds, metals or any other form of material which enables the subsequent electronic detection of hybridization of a target sequence to probe elements. A plurality of probe elements can be located in the same physical location on e-array, the probe elements being deposited as mixtures. A plurality of probe elements can be located in the same physical location on e-array, the probe elements being deposited sequentially. A plurality of probe elements can be located in the same physical location on e-array, the probe elements being synthesized, and others being deposited individually or as mixtures.

The present invention provides probes elements that may be used on the same substrate that is employed for different types of biological sample testing, such as, for example, immunohistochemistry or gene expression. In such aspects, probe elements may be deposited before, during or after the other test method, on the same or different region of substrate as used for the other test. At least one of chemicals, other materials, reagents, and enzymes which will have utility for a test or assay, can be co-located with probe elements. Probe elements can be of any nucleic acid structure, including, but not limited to, oligonucleotides, the locked nucleic acid (“LNA”) type, peptide nucleic acid (“PNA”) type, or the micro RNA type (“miRNA”). Any lengths of these probes are permitted. Probe elements can be designed to be complementary to known genome nucleic acid sequences, designed to hybridize to putative sequences, or are designed to identify mutations. In an aspect of the present invention, the e-array probes can be designed with chemical modifications to detect the methylation states of CpG-island segments of the original sample DNA.

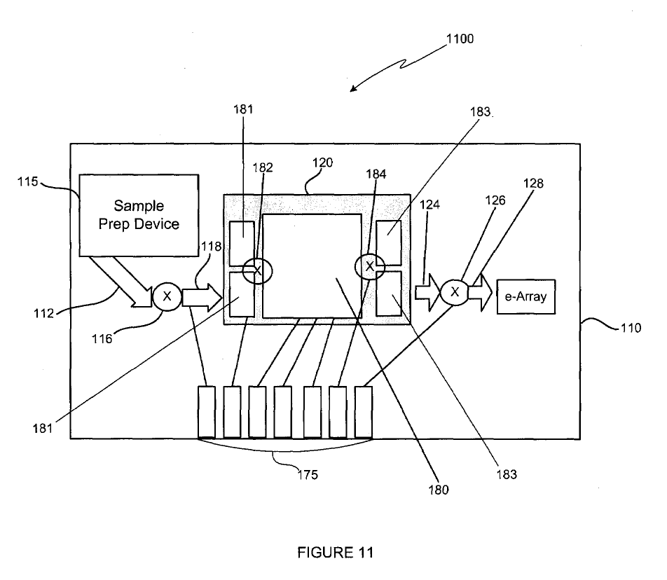

With reference to FIG. 11, apparatus 1100, according to various embodiments of the present invention, is illustrated. Apparatus 1100 can include substrate 110, sample prep device 115, PCR device 120, and e-array 130. In various embodiments of the present invention, sample prep device 115, PCR device 120, and e-array 130 are coupled to a surface of substrate 110, as described herein.

In various embodiments, sample prep device 115, PCR device 120, and e-array 130 can be coupled to one another in series, as described herein. Apparatus 1100 can also include prepped sample 112, valve 116, PCR entry 118, amplicons 124, valve 126 and e-array entry 128, as described herein.

Exemplary apparatus 1100 details electrical contacts 175 and PCR device 120. PCR device can have a plurality of chambers as described above. In an exemplary embodiment, PCR device 120 can include prime and/or reagents chamber 181, thermal cycling chamber 180, and amplicon collection chamber 183. In an aspect of this exemplary embodiment, prime and/or reagents chamber 181 can be controllably coupled to thermal cycling chamber 180 by valve 182, and thermal cycling chamber 180 can be controllably coupled to amplicon collection chamber 183 by valve 184. Each individual contact of electrical contacts 175 can be coupled to an individual element of apparatus 1100. For example, individual contacts of electrical contacts 175 can be coupled to each of the valves, to each of the chambers, to heating/cooling mechanisms of thermal cycling chambers, to thermal couples monitoring temperature, and the like. Electrical contacts 175 allow control of apparatus 1100 by an external instrument or system.

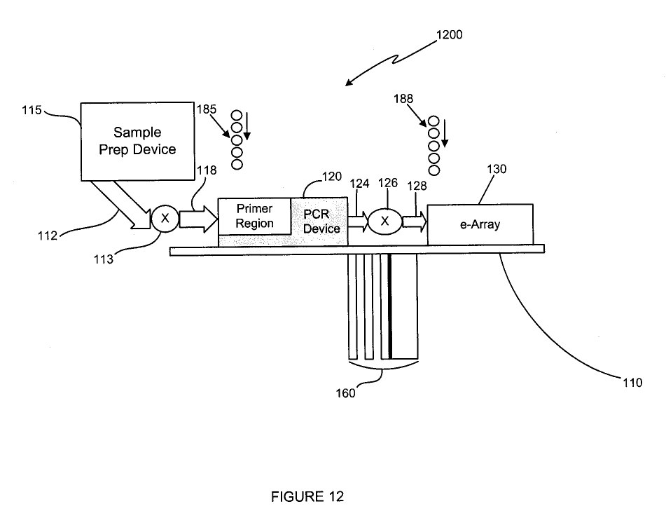

Finally, with reference to FIG. 12, a method of manufacturing an apparatus of the present invention is illustrated, according to various embodiments of the present invention. Methods of manufacturing a lab-on-chip apparatus can include coupling a sample preparation device 115 to one end of a surface of a substrate 110, coupling a PCR device 120 to the surface of the substrate 110, and coupling an e-array 130 to a distal end of the surface of the substrate 110. The method can also include fluidically connecting the sample preparation device 115 to the PCR device 120, and can include fluidically connecting the PCR device 120 to the e-array 130. The method can include placing at least one fluid metering device 113 in a fluidic connection 112, 118 between the sample preparation device 115 and the PCR device 120. In addition, the method can include placing at least one fluid metering device 126 in a fluidic connection 124, 128 between the PCR device 120 and the e-array 130. In various embodiments, a method of manufacture can include coupling a plurality of electrical conductors 160 to each of the sample preparation device 115, the PCR device 120, and the e-array 130. The method can include coupling at least one of the plurality of electrical conductors 160 to one of the fluid metering device 113, 126. In an aspect of the various embodiments, the method can include forming substrate 110 that has an interdigitated gold array embedded into substrate 110 and active as plurality of electrical conductors 160. In an exemplary embodiment, electrochemical probe elements as described herein can be coupled to the interdigiated gold array.

In an aspect of the present invention, a method of manufacture 1200 can include coupling all of the sample preparation devices 115, PCR devices 120, and e-arrays 130 to a common support or substrate 110. In another aspect, a method of manufacture can include coupling PCR device 120 and e-array 130 to a common support or substrate 110. In aspects of the present invention, a method of manufacture can include coupling PCR device 120 and e-array 130 to separate substrates, but contained within the same overall apparatus so as to allow direct transfer of PCR products to the e-array 130. Method of manufacture can include forming a substrate 110 from any of the types of circuit boards commonly used in the electronics industry to attach active and passive semiconductor devices. Methods of manufacture can include treating various portions of substrate 110 differently to provide at least one of chemical, thermal, electrical, and biological compatibility of that particular step or device of the process that is to be performed. Methods of manufacture can include attaching or coupling of the sample preparation device 115, PCR device 120, and e-array 130 to substrate 110 by soldering, welding, gluing, thermal means, chemical means, or the use of intermediate materials to provide the required attachment characteristics. Fluids, reagents, samples, amplicons, and other materials may be transported between the various portions of or device on support via micro-channels or tubing.

In various embodiments, primers can be deposited 185 on to a portion of PCR 120. Primers can be deposited 185 via contact printing, non-contact printing, stamping, electrospray, or acoustic ejection of droplets. Primers can be synthesized before, during, or after deposition 185.

In various embodiments, e-array probes elements or mixtures of can be previously prepared and then deposited 188 in liquid, gel, or solid form onto the support via contact printing, non-contact printing, stamping, electrospray, or acoustic ejection of droplets on to the e-array 130. In an aspect of the embodiments, some or all of the e-array probe elements can be synthesized on the e-array portion of substrate, including, but not limited to, chemical synthesis, light-stimulated synthesis, electrically-stimulated synthesis, and magnetically-stimulated synthesis. The e-array 130 can include probe elements of any size or shape, and any quantity of unique or replicate probes.

In an aspect of the invention, e-array probe elements can be deposited 188 and then attached or coupled to intermediate materials between probe element and electrical contact in substrate. Probe elements can be deposited 188 and then conjugated with or attached to other materials in order to provide attachment to either the support or the target sequence or intermediate molecules between target sequence and probe element. Probe elements can contain additional molecules, compounds, metals or any other form of material which enables the subsequent electronic detection of hybridization of a target sequence to probe element. A plurality of probe elements can be located in the same physical location on e-array 130, the probe elements being deposited 188 as mixtures. A plurality of probe elements can be located in the same physical location on e-array 130, the probe elements being deposited 188 sequentially. A plurality of probe elements can be located in the same physical location on e-array 130, the probe elements being synthesized, and others being deposited 188 individually or as mixtures.

The present invention has been described above with reference to a number of exemplary embodiments. It should be appreciated that the particular embodiments shown and described herein are illustrative of the invention and its best mode and are not intended to limit in any way the scope of the invention as set forth in the claims. Those skilled in the art, having read this disclosure, will recognize that changes and modifications may be made to the exemplary embodiments without departing from the scope of the present invention. Although certain preferred aspects of the invention are described herein in terms of exemplary embodiments, such aspects of the invention may be achieved through any number of suitable means now known or hereafter devised. Accordingly, these and other changes or modifications are intended to be included within the scope of the present invention.

We claim:

1. An apparatus for performing sample preparation, PCR and electronic detection of hybridization, the apparatus comprising:
a substrate;
a sample preparation device coupled to the substrate and operable for receiving a biological sample and for preparing said biological sample for PCR;
a PCR device coupled to the substrate and operable to receive the sample from the sample preparation device and to perform PCR on at least one nucleic acid target from the sample to produce at least one target amplicon; and
an electronic detection microarray device coupled to the substrate operable to receive the at least one target amplicon and to detect by an electrical means a hybridization event of the at least one target amplicon to at least one probe bound on a surface of the electronic detection microarray.

2. The apparatus according to claim 1, further comprising a plurality of electrical contacts coupled to at least one of the sample preparation device, the PCR device, and the electronic detection microarray.

3. The apparatus according to claim 1, wherein the substrate comprises at least one of silicon, quartz, glass, and a polymeric material.

4. The apparatus according to claim 1, further comprising a coating on the substrate, the coating between the substrate and at least one of the sample preparation devices, the PCR device, and the electronic detection microarray.

5. The apparatus according to claim 1, wherein the substrate comprises a plurality of electrical conductors coupleable to at least one of the sample prep device, the PCR device, and the e-array device.

6. The apparatus according to claim 5, wherein the e-array comprises a plurality of probe elements probes coupled to the plurality of electrical conductors in the substrate.

7. The apparatus according to claim 1, further comprising a chamber enclosing at least two of the sample prep device, the PCR device, and the e-array device.

8. A lab-on-chip apparatus comprising:
a non-conductive substrate comprising a first surface and a second surface opposite to the first surface;
a sample deposition port on the first surface and positioned at one end of the non-conductive substrate;
a heating member in the first surface;
a plurality of chambers in communication with the sample deposition port and in thermal communication with the heating member, the plurality of chambers operable for PCR;
a first plurality of electrical conductors in communication with the heating element and the plurality of chambers, a distal end of each of the first plurality of electrical conductors coupleable to an external device;
an e-array device comprising a plurality of probe elements coupled to the first surface and distal to the sample deposition port, the e-array device in communication with the plurality of chambers; and
a second plurality of electrical conductors in communication with the plurality of probe elements, a distal end of each of the second plurality of electrical conductors coupleable to an external device.

9. The apparatus according to claim 8, further comprising a fluid movement device in communication with at least one of the sample deposition port, the plurality of chambers, and the e-array device.

10. The apparatus according to claim 8, further comprising at least one fluid metering device between at least one of the sample deposition port, the plurality of chambers, and the e-array device.

11. The apparatus according to claim 10, wherein the at least one fluid metering device is coupled to at least one of a third plurality of electrical conductors and a distal end of each of the third plurality of electrical conductors coupleable to an external device

12. The apparatus according to claim 8, further comprising a plurality of primers deposited in at least one of the plurality of chambers.

13. The apparatus according to claim 8, further comprising a sample preparation device coupled to the sample deposition port and in communication with the plurality of chambers.

14. The apparatus according to claim 8, further comprising a chamber enclosing at least one of the sample deposition port, the plurality of chambers, and the e-array device.

15. The apparatus according to claim 8, wherein the probe elements are electrical probe elements operable to hybridize to a target sequence and operable to produce an electrical signal upon hybridization of the target sequence to the electrical probe.

16. The apparatus according to claim 8, wherein the substrate is formed from at least one of silicon, ceramic, glass, and quartz.

17. The apparatus according to claim 16, further comprising an external instrument operable to at least one of controlling the apparatus and collecting data from the apparatus.

18. A method of manufacturing a lab-on-chip apparatus, the method comprising:
coupling a sample preparation device to one end of a surface of a substrate;
coupling a PCR device to the surface of the substrate;
fluidically connecting the sample preparation device to the PCR device;
coupling an e-array device to a distal end of the surface of the substrate; and
fluidically connecting the PCR device to the e-array device.

19. The method according to claim 18, further comprising placing at least one fluid metering device in at least one of a fluidic connection between the sample preparation device and the PCR device, and a fluidic connection between the PCR device and the e-array.

20. The method according to claim 18, further comprising coupling a plurality of electrical conductors to each of the sample preparation device, the PCR device, and the e-array device.
